(19) United States
(12) Patent Application Publication
(10) Pub. No.: US 2019/0392295 A1
(43) Pub. Date: Dec. 26, 2019

(54) INFORMATION PROCESSING DEVICE, METHOD, AND PROGRAM THAT USE DEEP LEARNING

(71) Applicant: NEC Corporation, Minato-ku, Tokyo (JP)

(72) Inventor: Yusuke OI, Tokyo (JP)

(73) Assignee: NEC Corporation, Minato-ku, Tokyo (JP)

(21) Appl. No.: 16/481,891

(22) PCT Filed: Dec. 5, 2017
(86) PCT No.: PCT/JP2017/043565

§ 371 Date: Jul. 30, 2019

(30) Foreign Application Priority Data
Feb. 2, 2017 (JP) 2017-017440

(51) Int. Cl. G06N 3/04; G06N 20/00; G06F 17/18; G06F 16/901

(52) U.S. Cl. CPC G06N 3/0472; G06F 16/901; G06F 17/18; G06N 20/00

(57) ABSTRACT

An information processing device 20 is provided with: a deep learning prediction unit 21 that performs a prediction process using a deep learning model on the basis of data stored in a database 30, in order to enable extraction of primary explanatory variables in a deep learning model; and a variable extraction unit 22 that performs a multiple regression analysis with a result of prediction obtained by the deep learning prediction unit 21 as an objective variable and with the data as an explanatory variable, and determines the variable for use in explaining the prediction result of the deep learning model on the basis of a result of the multiple regression analysis.

### TECHNICAL FIELD

The present invention relates to an information processing device that extracts variables necessary for better explaining a prediction value obtained by deep learning.

### BACKGROUND ART

A company such as a financial institution owns a marketing customer information file (MCIF: an enormous quantity of single source data, unitarily managed by using customer numbers, including a wide variety of customer information such as customer attribute information, information of products owned by customers, various contract information of a customer, customer transaction information, information of channel used by customers, customer contact information of customers, promotion result information to customers, questionnaire information of customers, revenue information of customers, and external information) as attribute data of customers. For example, the customer attributes are gender and age. The information of product owned by a customer contains information on a savings account (including monetary amount information), information on fluctuations in total assets, information on the proportion of savings account as a percentage of total assets, and the like. The customer-used channel information contains information on the annual number of times of using an automated teller machine (ATM), information on the annual number of times of using an ATM with payment of fees, information on the annual number of times of using a teller window, and the like. The customer promotion result information contains information indicating whether or not a customer responded to a direct mail piece and the like.

In some cases, a company such as a financial institution analyzes MCIF data to extract a customer insight lying behind the behavior of a consumer purchasing a product (for example, a credit card loan provided by the financial institution). The customer insight is an underlying real intention or core of a customer's behavior or attitude. For example, in the case of customers who use credit card loans, the number of deposits and withdrawals tends to increase by 50% on the previous month of a bonus month. Hereinafter, the term “customer insight” will be sometimes represented by a consumer insight since a customer is be included in a consumer in some cases. Moreover, a customer will be widely represented by a consumer in some cases.

For the analysis of the MCIF data, a logistic regression analysis is mainly used. For a selection of explanatory variables of the logistic regression analysis, for example, a stepwise method is used.

In the case of using the logistic regression analysis, the number of explanatory variables for use in obtaining an appropriate analysis result is about less than 100. In general, however, data to be analyzed (MCIF data or the like) includes about 10,000 pieces of data that can be explanatory variables. Therefore, an analyst needs to narrow the explanatory variables for use in a regression analysis to about 100 variables on the basis of a tacit knowledge or the like.

Moreover, the stepwise method often used in a model generation of a logistic regression uses an approach of repeating a model evaluation while adding explanatory variables one by one. The analyst adds the explanatory variables each of which seems to most better explain an objective variable in turn and then terminates the addition of explanatory variables at the timing when the analyst determines that a model of achieving a required prediction accuracy has been constructed. Therefore, the constructed model is likely to strongly reflect an analyst's subjective view. Incidentally, the term “better explain the objective variable” corresponds to “highly influence the objective variable (the standard partial regression coefficient is high).”

Specifically, in a machine learning technique (a multiple regression analysis, decision tree learning, or the like) of white box type, wherein a found rule can be explained, including a logistic regression analysis, prediction is performed on the basis of limited explanatory variables, which have been selected from the analyst's subjective view. This may lead to an occurrence of missing some explanatory variables in the prediction.

Deep learning has received attention as an analytical framework for automating selection of explanatory variables. Deep learning includes a function of automatically extracting feature values having a large influence on an objective variable from explanatory variables.

Non Patent Literature (NPL) 1 describes analysis of MCIF data with deep learning. NPL 1 describes that deep learning is able to increase prediction accuracy by 10 points or more in comparison with the conventional machine learning.

Moreover, NPL 1 describes that new credit card loan holders for the future three months have been predicted, with input of data for past 12 months of customers, from the MCIF. First, a logistic regression model as a conventional machine learning and a deep learning model have been constructed by using learning data (training data) composed of past data for 12 months and correct data for three months. Thereafter, both models have been evaluated by using another verification data for 15 months. Specifically, data for 12 months have been input to each model out of the verification data and then the prediction result of each model is compared with correct data for three months for the evaluation.

Use of the deep learning model enables analysis without narrowing explanatory variables, thereby solving the above problem of missing some explanatory variables in some cases when narrowing the explanatory variables.

### CITATION LIST

### Non Patent Literature

NPL 1: “Experimental study on artificial intelligence for financial behaviors,” by Tomohiro Kagei, Yasuyuki Tomonaga, and Banri Matsushita, Japan Marketing Academy, Conference Proceedings vol. 5 2016, pp. 197 to 208, issued on Oct. 12, 2016

### SUMMARY OF INVENTION

### Technical Problem

Deep learning, however, is an analytical technique of black box type in which a found rule cannot be explained. In other words, the contents of a model generated from data cannot be known when using deep learning. Therefore, an analyst is not able to know which explanatory variable influences a prediction result.

The fact that deep learning is a black-box-type technique provides a hurdle when using deep learning in a field required to give sufficient explanation. The field required to give sufficient explanation is, for example, a marketing task. In the marketing task, it is desirable to extract a customer insight for use in explaining a consumer behavior (holding a credit card loan anew or the like). The customer insight is, for example, a temporary shortage of money in hand.

An object of the present invention is to enable extraction of major (primary) explanatory variables in a deep learning model.

### Solution to Problem

An information processing device using deep learning according to the present invention includes: a deep learning prediction means for performing a prediction process by using a deep learning model on the basis of data stored in a database; and a variable extraction means for performing a multiple regression analysis with a result of prediction obtained by the deep learning prediction means as an objective variable and with the data stored in the database as an explanatory variable and for determining the variable for use in explaining the prediction result of the deep learning model on the basis of a result of the multiple regression analysis.

An information processing method using deep learning according to the present invention includes the steps of: performing a prediction process using a deep learning model on the basis of data stored in a database; and performing a multiple regression analysis with a result of prediction of the prediction process as an objective variable and with the data stored in the database as an explanatory variable and determining the variable for use in explaining the prediction result of the deep learning model on the basis of a result of the multiple regression analysis.

An information processing program for using deep learning according to the present invention causes a computer to perform the processes of: performing a prediction process by using a deep learning model on the basis of data stored in a database; and performing a multiple regression analysis with a result of prediction of the prediction process as an objective variable and with the data stored in the database as an explanatory variable and determining the variable for use in explaining the prediction result of the deep learning model on the basis of a result of the multiple regression analysis.

### Advantageous Effects of Invention

The present invention enables extraction of primary explanatory variables (variables better explaining a prediction result) in a deep learning model.

### BRIEF DESCRIPTION OF DRAWINGS

FIG. 1 is a block diagram illustrating the configuration of an automatic customer insight extraction device (customer insight automatically extracting device) according to an exemplary embodiment.

FIG. 2 is a flowchart illustrating a pre-training process.

FIG. 3 is a flowchart illustrating a deep learning prediction process.

FIG. 4 is an explanatory diagram illustrating an example of a prediction result (prediction value) associated with a record ID (customer ID).

FIG. 5 is an explanatory diagram illustrating an example of the prediction result (prediction value) and attribute data #2.

FIG. 6 is a flowchart illustrating an explanatory variable extraction process.

FIG. 7 is a block diagram illustrating the configuration of an automatic customer insight extraction device according to another exemplary embodiment.

FIG. 8 is an explanatory diagram illustrating an example of a table created by a prediction result aggregation unit.

FIG. 9 is an explanatory diagram illustrating a state of a comparison between a result of evaluation using a logistic regression model and a result of evaluation using a deep learning model.

FIG. 10 is a flowchart illustrating a prediction result aggregation process.

FIG. 11 is an explanatory diagram illustrating an example of prediction scores by logistic regression and prediction scores by deep learning for customers.

FIG. 12 is an explanatory diagram illustrating an example of a table in which prediction scores by logistic regression and prediction scores by deep learning are set so as to be associated with customer IDs.

FIG. 13 is an explanatory diagram illustrating an example of a table in which attribute values and prediction scores by deep learning are set so as to be associated with customer IDs.

FIG. 14 is a block diagram illustrating a main part of an information processing device that uses deep learning.

FIG. 15 is a block diagram illustrating a main part of another information processing device that uses deep learning.

### DESCRIPTION OF EMBODIMENT

### Exemplary Embodiment 1

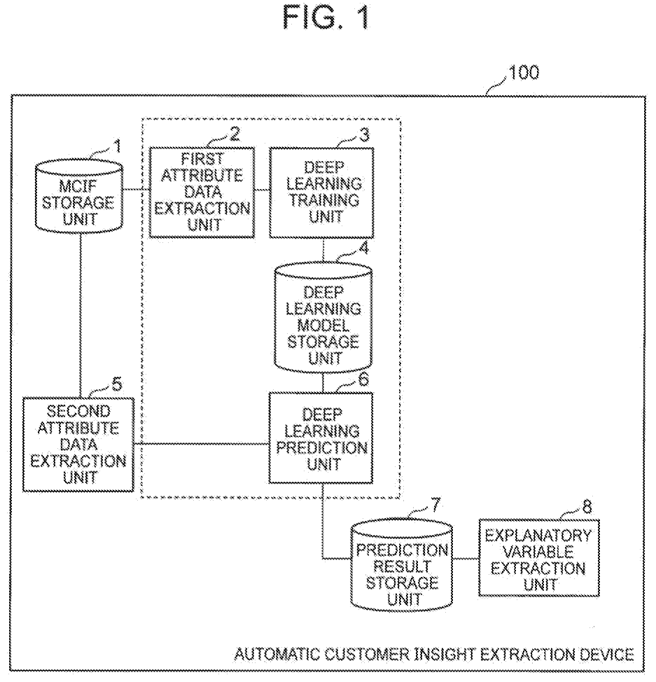

Hereinafter, an exemplary embodiment of the present invention will be described with reference to accompanying drawings. FIG. 1 is a block diagram illustrating the configuration of an automatic customer insight extraction device 100 according to an exemplary embodiment of the present invention. As illustrated in FIG. 1, the automatic customer insight extraction device 100 includes an MCIF storage unit 1, a first attribute data extraction unit 2, a deep learning training unit (training unit) 3, a deep learning model storage unit 4, a second attribute data extraction unit 5, a deep learning prediction unit (prediction unit) 6, a prediction result storage unit 7, and an explanatory variable extraction unit 8. In FIG. 1, the blocks enclosed by a dashed line are related to deep learning.

The automatic customer insight extraction device 100 is implemented by an information processing device such as a personal computer, a server, or the like. Specifically, the first attribute data extraction unit 2, the training unit 3, the second attribute data extraction unit 5, the prediction unit 6, and the explanatory variable extraction unit 8 are implemented by an information processing device having a central processing unit (CPU) that performs processes according to programs stored in a storage device such as a read-only memory (ROM), a hard disk, and the like. This exemplary embodiment supposes an example that the automatic customer insight extraction device 100 is implemented by a server.

It should be noted that, however, the first attribute data extraction unit 2, the training unit 3, the second attribute data extraction unit 5, the prediction unit 6, and the explanatory variable extraction unit 8 are also able to be implemented by individual hardware.

The MCIF storage unit 1 is a database that stores an MCIF. The MCIF storage unit 1 may be installed outside the automatic customer insight extraction device 100 or may be installed so as to be accessible via communication networks. The first attribute data extraction unit 2 extracts attribute data and correct data (hard target) used by the training unit 3 from the MCIF. The training unit 3 performs learning by using the attribute data and the correct data for learning, which have been extracted by the first attribute data extraction unit 2, to create a deep learning model. The deep learning model storage unit 4 holds a result of learning by the training unit 3 (deep learning model).

The second attribute data extraction unit 5 extracts attribute data used by the prediction unit 6 and the explanatory variable extraction unit 8 from the MCIF. The prediction unit 6 inputs the deep learning model from the deep learning model storage unit 4, performs prediction for the attribute data extracted by the second attribute data extraction unit 5, and performs scoring. The prediction result storage unit 7 pairs the attribute data extracted by the second attribute data extraction unit with a soft target (a score associated with corresponding attribute data by the prediction unit 6) for each record and holds them.

The explanatory variable extraction unit 8 performs a multiple regression analysis by using the attribute data and the soft target read from the prediction result storage unit 7 and extracts primary explanatory variables that better explain an objective variable (soft target) corresponding to the attribute data (k explanatory variables each having a great weight value or standard partial regression coefficient in a multiple regression equation).

The k value, which is an arbitrarily settable natural number, is, for example, a value equivalent to 5% of the total.

Subsequently, the operation of the automatic customer insight extraction device 100 will be described. The automatic customer insight extraction device 100 performs a pre-training process (pre-training: deep learning training process), a deep learning prediction process, and an explanatory variable extraction process.

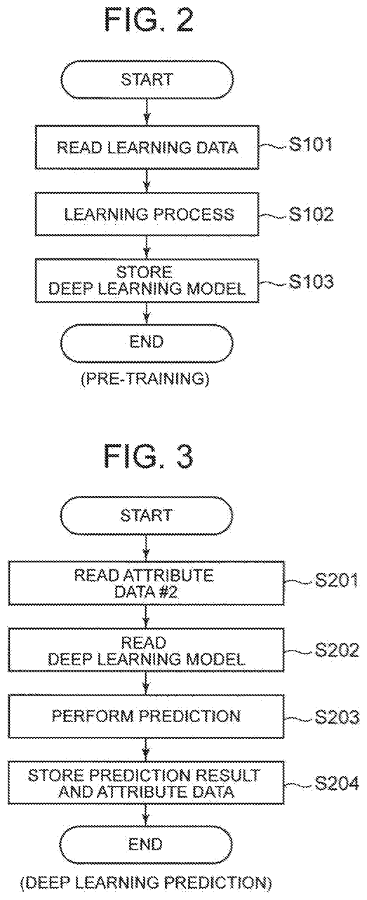

FIG. 2 is a flowchart illustrating a pre-training process. In the pre-training process, the first attribute data extraction unit 2 reads attribute data of a member (customer) and correct data (hard target) from the MCIF storage unit 1 and considers them as learning data (step S101).

The first attribute data extraction unit 2 extracts all attribute data (assumed to be attribute data #1), for example, for a predetermined period (a period for learning) as explanatory variables in the process of step S101. The training unit 3 performs learning by using the learning data having been read out (step S102).

The training unit 3 stores the deep learning model, which have been created by learning, into the deep learning model storage unit 4 (step S103).

FIG. 3 is a flowchart illustrating a deep learning prediction process. In the deep learning prediction process, the second attribute data extraction unit 5 reads out the attribute data of a member (customer) from the MCIF storage unit 1 (step S201). The prediction unit 6 reads out the deep learning model from the deep learning model storage unit 4 (step S202).

The prediction unit 6 extracts attribute data (assumed to be attribute data #2) for a period (unlearning period) different from the period to which the aforementioned attribute data #1 belongs as explanatory variables in the process of step S201.

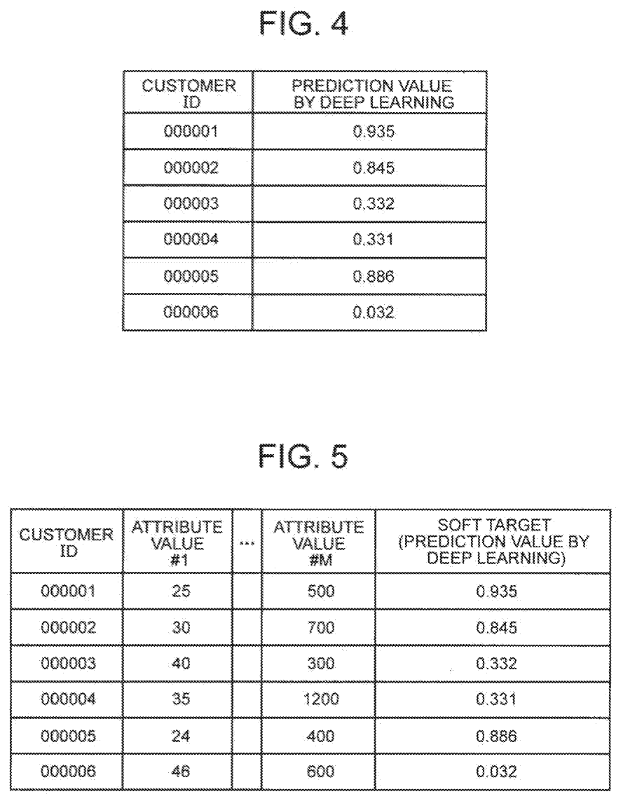

The prediction unit 6 performs prediction by using the deep learning model read out in the process of step S202 with the attribute data #2 as input data and calculates the prediction scores (prediction values) (step S203). As illustrated in FIG. 4, the prediction results (prediction values) are associated with record IDs (customer IDs).

The prediction unit 6 pairs the prediction result (prediction value) obtained in the process of step S203 and the attribute data #2 with a record ID and stores them into the prediction result storage unit 7 (step S204). FIG. 5 is an explanatory diagram illustrating an example of the prediction result (prediction value) and attribute data #2 stored in the prediction result storage unit 7. In the example of FIG. 5, the attribute data #2 includes data related to M types of attributes ranging from an attribute value #1 to an attribute value #M.

Incidentally, the prediction value obtained in the process of step S203 is positioned as a prediction value of an objective variable (soft target). The prediction value is considered to be an objective variable in a multiple regression analysis.

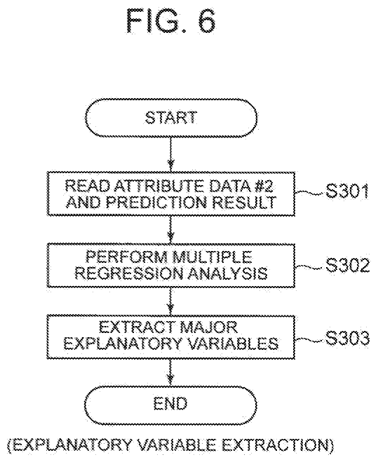

FIG. 6 is a flowchart illustrating an explanatory variable extraction process. In the explanatory variable extraction process, the explanatory variable extraction unit 8 reads out the attribute data #2 and the soft target, more specifically the prediction value calculated based on a deep learning model, from the prediction result storage unit 7 (step S301). The explanatory variable extraction unit 8 performs a multiple regression analysis by using the attribute data #2 and the soft target having been read out (step S302). In the process of step S302, the explanatory variable extraction unit 8 considers the attribute data #2 as an explanatory variable for the multiple regression analysis and considers the prediction value obtained in the process of step S203 as an objective value for the multiple regression analysis.

The explanatory variable extraction unit 8 extracts k explanatory variables each having a great weight value (partial regression coefficient) in the multiple regression equation derived from the multiple regression analysis in step S302 as primary explanatory variables (step S303).

The extracted explanatory variables are assumed to be primary explanatory variables for a deep learning model. The explanatory variables have been obtained by a machine learning technique of white box type. Therefore, this exemplary embodiment enables reduction in possibilities of missing explanatory variables and enables grasping of variables influencing a prediction result. In other words, an analyst is able to explain variables influencing the prediction result even in the case of using deep learning.

As described above, in this exemplary embodiment, data for an unlearning period is predicted by using the deep learning model created from the attribute data #1 for the period for learning and then a multiple regression analysis is performed with the score (prediction value) of the prediction result as a soft target by using the attribute data #2 and the soft target for the unlearning period, thereby enabling the primary explanatory variables of the deep learning model to be extracted.

Moreover, the automatic customer insight extraction device 100 of this exemplary embodiment is able to identify an explicable variable that influences the prediction result, thereby enabling a customer insight to be inferenced from the influence (the partial regression coefficient of the multiple regression analysis).

### Exemplary Embodiment 2

While the multiple regression analysis is performed by using all of prediction results obtained by deep learning in the first exemplary embodiment, objective variables in the multiple regression analysis are narrowed down in a second exemplary embodiment.

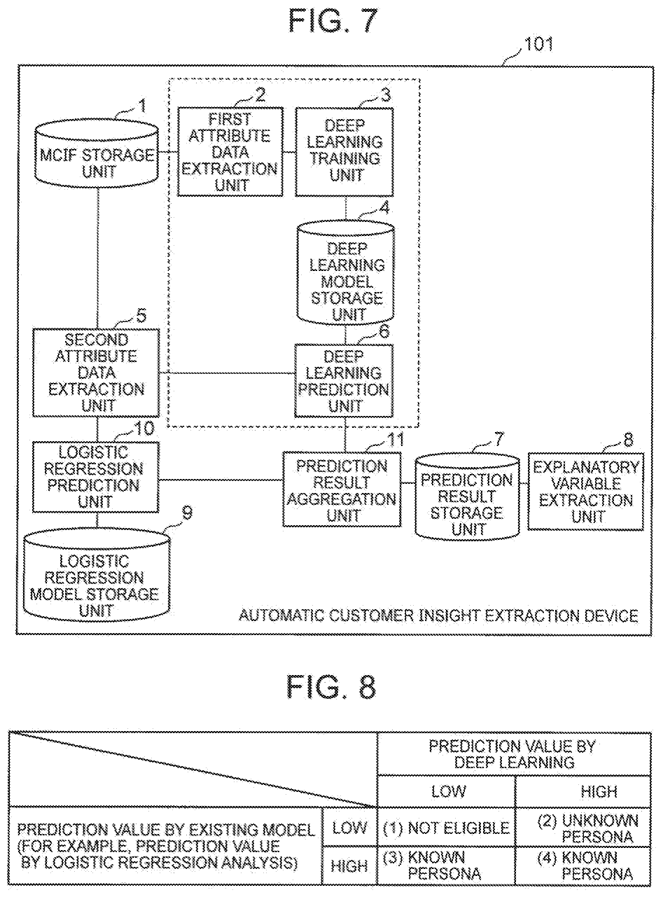

FIG. 7 is a block diagram illustrating the configuration of an automatic customer insight extraction device 101 according to the second exemplary embodiment. As illustrated in FIG. 7, the automatic customer insight extraction device 101 includes a logistic regression model storage unit 9, a logistic regression prediction unit 10, and a prediction result aggregation unit 11, in addition to the blocks included in the automatic customer insight extraction device 100 illustrated in FIG. 1.

The logistic regression prediction unit 10 and the prediction result aggregation unit 11 are implemented by the CPU that performs processes according to programs stored in storage devices such as a ROM or a hard disk in a server, for example. The logistic regression prediction unit 10 and the prediction result aggregation unit 11, however, may be implemented by individual hardware.

The logistic regression model storage unit 9 holds a model (logistic regression model) using a logistic regression. The logistic regression model is previously created and stored in the logistic regression model storage unit 9. In the case where the objective variable of the logistic regression model is, for example, a new credit card loan holder, the explanatory variable of the logistic regression model is attribute data of a customer who may have a large influence on the new credit card loan holder.

The logistic regression prediction unit 10 reads out a logistic regression model (hereinafter, referred to as “existing model”) from the logistic regression model storage unit 9 and performs prediction for the attribute data #2 extracted from the MCIF storage unit 1 by the second attribute data extraction unit 5 to perform scoring.

The prediction result aggregation unit 11 divides data for which scoring is performed by the prediction unit 6 and the logistic regression prediction unit 10 into two parts: high-score data ranking in the top N % of all (specifically, having great prediction values) and low-score data as remaining data. The N value is arbitrarily settable and may be, for example, “5.” The prediction result aggregation unit 11 creates a table as illustrated in FIG. 8 to facilitate data comparison. Unknown personas are set on the table. In this specification, the term “persona” means customer insight.

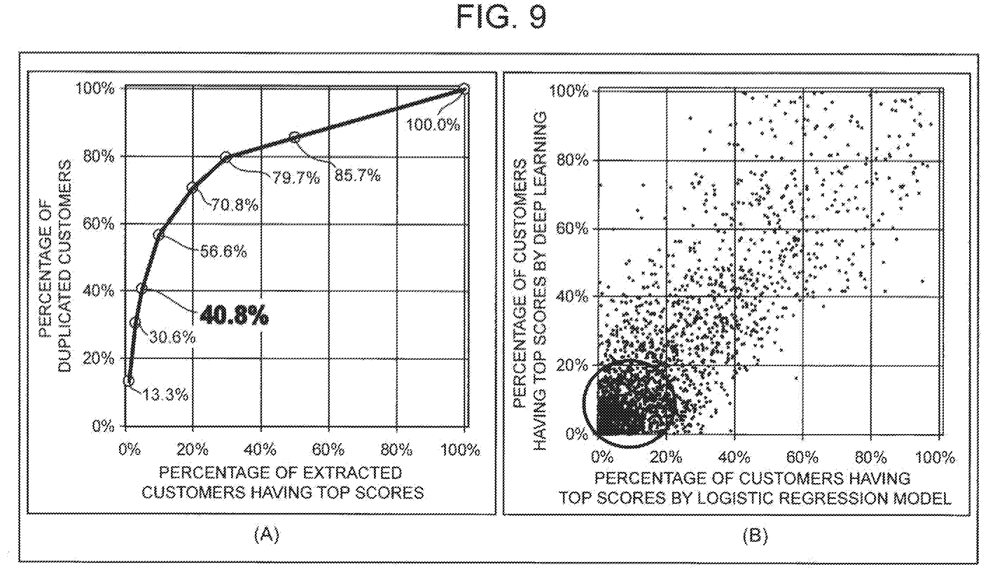

FIG. 9 is an explanatory diagram illustrating a state of a comparison between a result of evaluation using a logistic regression model, which is described in NPL 1, and a result of evaluation using a deep learning model. The evaluation described in NPL 1 is specifically a prediction of new credit card loan holders (extraction of customers highly expected [having high scores] to hold credit card loans anew). FIG. 9(A) illustrates percentages of customers duplicated between a result of evaluation with the logistic regression model and a result of evaluation with the deep learning model in the case of extracting customers having high scores. FIG. 9(B) is an explanatory diagram plotting customers associated with percentages in the case of displaying the scores of correct customers with deep learning and scores of correct customers with logistic regression analysis by percentages.

As illustrated in FIG. 9(A), the percentage of duplicated customers is 40.8% when 5% of customers are extracted in descending order of scores based on the result of evaluation with the deep learning model and 5% of customers are extracted in descending order of scores based on the logistic regression model. Moreover, customers having high scores among the correct customers are concentrated in distribution both in the case of evaluation with the logistic regression model and in the case of evaluation with the deep learning model (see the area enclosed by a circle in FIG. 9(B)) as illustrated in FIG. 9(B), while there are also correct customers (correct customers having high scores in the case of evaluation with the deep learning model) distributed apart from the distribution concentrated area. This means that deep learning successfully extracted highly-expected customers who have not been extracted with the logistic regression analysis (in this example, customers who hold credit card loans anew).

In the second exemplary embodiment, analysis is performed for highly-expected customers who have not been extracted with the logistic regression analysis. Incidentally, these customers correspond to “(2) unknown personas” in FIG. 8.

In the second exemplary embodiment, the automatic customer insight extraction device 101 performs a pre-training process, a prediction result aggregation process, and an explanatory variable extraction process. The pre-training process and the explanatory variable extraction process in the second exemplary embodiment are performed in the same manner as the pre-training process and the explanatory variable extraction process in the first exemplary embodiment.

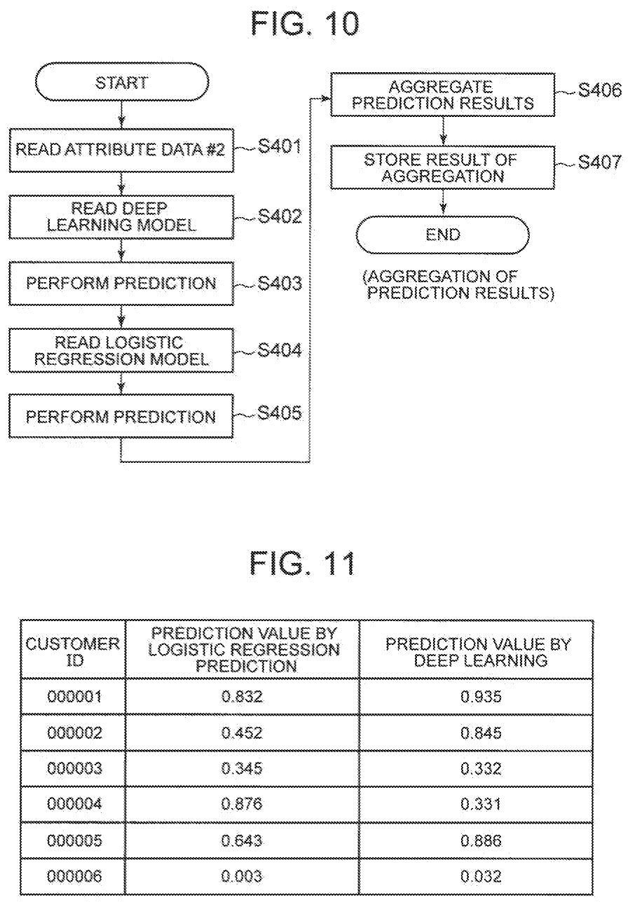

FIG. 10 is a flowchart illustrating the prediction result aggregation process. In the prediction result aggregation process, the second attribute data extraction unit 5 reads out the attribute data #2 of members (customers) from the MCIF storage unit 1 (step S401). The prediction unit 6 reads out the deep learning model from the deep learning model storage unit 4 (step S402).

The prediction unit 6 performs prediction with the deep learning model read out in the process of step S402 with the attribute data #2 as input data and calculates prediction scores (prediction values) (step S403).

The logistic regression prediction unit 10 reads out the logistic regression model from the logistic regression model storage unit 9 (step S404). The logistic regression prediction unit 10 performs prediction by using the attribute data #2 and the logistic regression model and calculates prediction scores (prediction values) (step S405).

The prediction result aggregation unit 11 aggregates the prediction scores by the deep learning model and prediction scores by the logistic regression to create the table as illustrated in FIG. 8 (step S406).

Specifically, the prediction result aggregation unit 11 classifies all prediction scores into two values. For example, the prediction scores ranking in the top N % of all are considered to be “high in prediction score” and other prediction scores are considered to be “low in prediction score.” Furthermore, the prediction scores are grouped as described below (see FIG. 8).

(1) Low in prediction score with deep learning (for example, ranking in the bottom [100-N]% of all) and low in prediction score with logistic regression

(2) High in prediction score with deep learning (for example, ranking in the top N % of all) and low in prediction score with logistic regression

(3) Low in prediction score with deep learning and high in prediction score with logistic regression

(4) High in prediction score with deep learning and high in prediction score with logistic regression

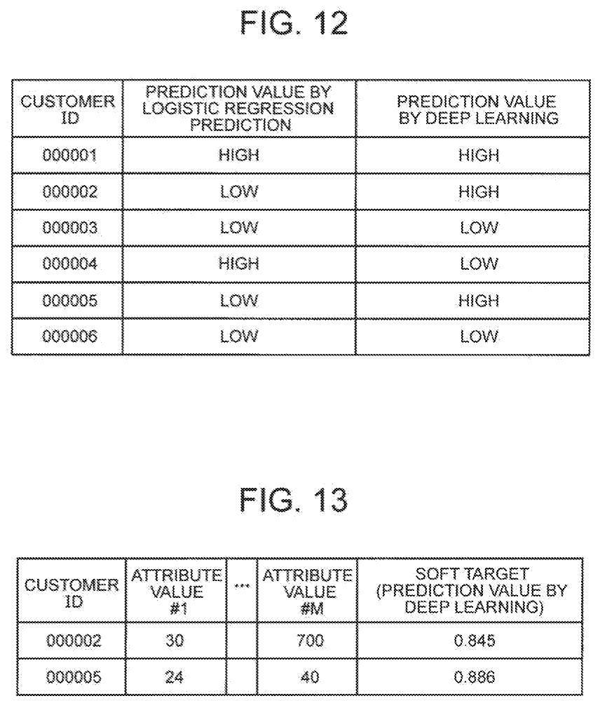

Specifically, the prediction result aggregation unit 11 provides a list of the prediction scores by the logistic regression analysis and the prediction scores by the deep learning for customers as illustrated in FIG. 11. Additionally, the prediction result aggregation unit 11 selects a high or low score class for each prediction score to create a table as illustrated in FIG. 12. Furthermore, the prediction result aggregation unit 11 aggregates the prediction scores to obtain the table illustrated in FIG. 8.

Thereafter, the prediction result aggregation unit 11 stores the attribute data and the prediction scores of data (samples) belonging to a group (sample group) having high prediction scores by the deep learning and low prediction scores by the logistic regression analysis among the aggregation result into the prediction result storage unit 7 (step S407). Specifically, the prediction result aggregation unit 11 extracts the attribute data and the prediction scores of the customer ID corresponding to data in which “the prediction score with deep learning is high and the prediction score with logistic regression analysis is low” on the table illustrated in FIG. 12 and then stores the attribute value and the prediction score (prediction value) with deep learning in association with a customer ID as illustrated in FIG. 13 into the prediction result storage unit 7.

Incidentally, the stored attribute data and prediction score are used as soft targets in the explanatory variable extraction process. Moreover, the attribute values correspond to a data group (attribute data #3) extracted from the attribute data #2. A customer having a high prediction score with deep learning and a low prediction score with logistic regression is determined to be a customer likely to behave according to an unknown customer insight that has not been considered in the existing model and the attribute value of the customer is separated from the attribute data #2 by segmentation and considered to belong to the attribute data #3.

Additionally, the explanatory variable extraction unit 8 reads out the attribute data #3 and the prediction value calculated based on the soft target, in other words, the deep learning model from the prediction result storage unit 7 and performs a multiple regression analysis on the basis thereof (see FIG. 6).

In addition to the advantageous effects of the first exemplary embodiment, this exemplary embodiment enables the following advantageous effects. Specifically, prediction is performed using an existing model and a model created by deep learning from MCIF data and the prediction results are compared with each other, thereby enabling extraction of a target that can be approached by using an existing model, a target that can be approached by using both models, and a target that has not been able to be approached by using the existing model. Furthermore, a multiple regression analysis is performed only for customer data that has not been approached due to a low prediction score with the existing model while having a high prediction score with the deep learning model, thereby enabling efficient extraction of explicable explanatory variables. Although the logistic regression model has been used as an existing model, in other words, the logistic regression analysis has been used as existing machine learning (naturally, not including deep learning) in this exemplary embodiment, another machine learning model of white box type may be used, instead of the logistic regression.

Although the second exemplary embodiment has been described by giving an example of inferencing a customer insight lying behind the behavior of a consumer purchasing a financial product (for example, a credit card loan) by analyzing MCIF data similarly to the first exemplary embodiment, the technique of comparing the score predicted by using an existing model with a score predicted by using a deep learning model after aggregation thereof and then approaching an unknown persona is also applicable to fields other than the financial field by replacing the MCIF storage unit 1 with a storage unit for storing other user information.

Particularly, the technique is widely applicable to a method in which the logistic regression analysis model is used. The method may include, for example, purchaser forecast of an electronic commerce (EC) site, purchase forecast of customers in a store, forecast of insurance subscribers, and the like. In the case of the purchaser forecast of an EC site, each of the above exemplary embodiments is applicable to the purchaser forecast of EC site visitors by replacing the MCIF storage unit 1 with an EC site user information storage unit.

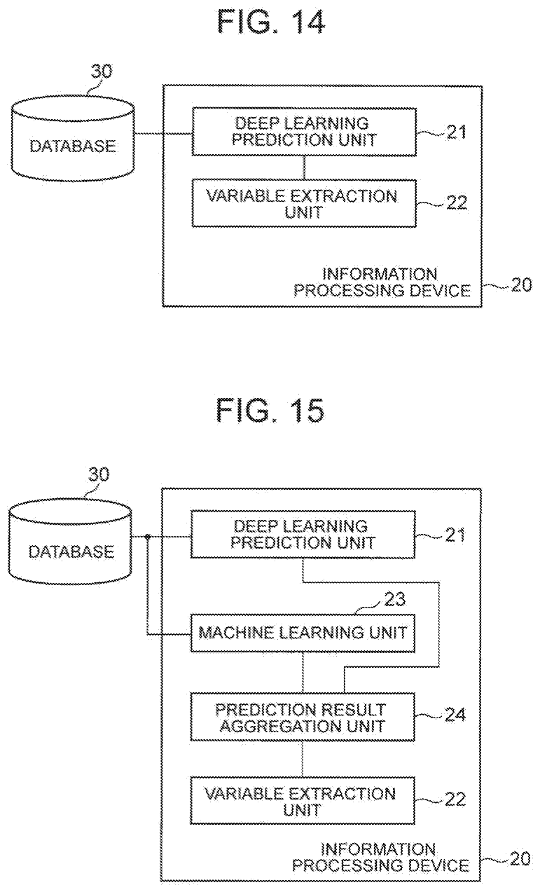

FIG. 14 is a block diagram illustrating a main part of an information processing device that uses deep learning according to the present invention. As illustrated in FIG. 14, the information processing device 20 (corresponding to the automatic customer insight extraction device 100 in the exemplary embodiment, except the MCIF storage unit 1, which is removed) includes a prediction unit 21 (implemented by the prediction unit 6 in the exemplary embodiment) that performs a prediction process by using a deep learning model on the basis of data stored in a database 30 (corresponding to the MCIF storage unit 1 in the exemplary embodiment) and a variable extraction unit 22 (implemented by the explanatory variable extraction unit 8 in the exemplary embodiment) that performs a multiple regression analysis with a result of prediction obtained by the prediction unit 21 as an objective variable and with the data stored in the database 30 as an explanatory variable and determines the variable for use in explaining the prediction result of the deep learning model on the basis of a result of the multiple regression analysis.

FIG. 15 is a block diagram illustrating a main part of another information processing device that uses deep learning according to the present invention. As illustrated in

FIG. 15, the information processing device 20 (corresponding to the automatic customer insight extraction device 101 in the exemplary embodiment, except the MCIF storage unit 1, which is removed) further includes a machine learning unit 23 (implemented by the logistic regression prediction unit 10 in the exemplary embodiment) that performs machine learning by using the data stored in the database 30 and a prediction result aggregation unit 24 (implemented by the prediction result aggregation unit 11 in the exemplary embodiment) that extracts a plurality of samples (for example, customers) that are included in a previously-determined first percentage (for example, 5%) of samples (for example, “customers having high prediction scores by the deep learning model” in the exemplary embodiment), which have been selected in descending order of the prediction score with the deep learning model, and included in a previously-determined second percentage (for example, 95%) of samples (for example, “customers having low prediction scores by the logistic regression analysis” in the exemplary embodiment), which have been selected in ascending order of the prediction score with the machine learning, wherein the variable extraction unit 22 may be configured to perform the multiple regression analysis with the data of the plurality of samples among the data stored in the database 30 as explanatory variables.

Although the database 30 is separated from the information processing device 20, the information processing device 20 may have a built-in database 30.

Although the present invention has been described with reference to the exemplary embodiments hereinabove, the present invention is not limited thereto. A variety of changes, which can be understood by those skilled in the art, may be made in the configuration and details of the present invention within the scope thereof.

This application claims priority to Japanese Patent Application No. 2017-017440 filed on Feb. 2, 2017, and the entire disclosure thereof is hereby incorporated herein by reference.

### REFERENCE SIGNS LIST

1 MCIF storage unit
2 First attribute data extraction unit
3 Deep learning training unit
4 Deep learning model storage unit
5 Second attribute data extraction unit
6 Deep learning prediction unit
7 Prediction result storage unit
8 Explanatory variable extraction unit
9 Logistic regression model storage unit
10 Logistic regression prediction unit
11 Prediction result aggregation unit
20 Information processing device
21 Deep learning prediction unit
22 Variable extraction unit
23 Machine learning unit
24 Prediction result aggregation unit
30 Database
100,101 Automatic customer insight extraction device

What is claimed is:

1. An information processing device using deep learning comprising:
a memory configured to store instructions; and
at least one processor configured to execute the instructions to:
perform a prediction process by using a deep learning model on the basis of data stored in a database; and
perform a multiple regression analysis with a result of prediction obtained by the prediction process as an objective variable and with the data as an explanatory variable and for determining the variable for use in explaining the prediction result of the deep learning model on the basis of a result of the multiple regression analysis.

2. The information processing device according to claim 1, wherein the processor executes the instructions to extract a predetermined number of explanatory variables that better explain the objective variable as variables for use in explaining the prediction result of the deep learning model from the explanatory variables in a multiple regression equation.

3. The information processing device according to claim 1, wherein the processor further executes the instructions to:
perform machine learning using the data stored in the database; and
extract a plurality of samples that are included in a previously-determined first percentage of samples, which have been selected in descending order of the prediction score with the deep learning model, and included in a previously-determined second percentage of samples, which have been selected in ascending order of the prediction score with the machine learning,
wherein when determining the variable, the processor executes the instructions to perform the multiple regression analysis with the data of the plurality of samples among the data stored in the database as explanatory variables.

4. The information processing device according to claim 3, wherein:
the database stores attribute data of customers of financial institutions; and
when extracting a plurality of the samples, the processor executes the instructions to perform positioning the plurality of samples as customers who behave according to customer insights, which have not been considered with the machine learning.

5. An information processing method, implemented by at least one processor, using deep learning comprising:
performing a prediction process using a deep learning model on the basis of data stored in a database; and
performing a multiple regression analysis with a result of prediction of the prediction process as an objective variable and with the data as an explanatory variable and determining the variable for use in explaining the prediction result of the deep learning model on the basis of a result of the multiple regression analysis.

6. The information processing method according to claim 5, wherein a predetermined number of explanatory variables that better explain the objective variable are extracted as variables for use in explaining the prediction result of the deep learning model from the explanatory variables in a multiple regression equation.

7. The information processing method according to claim 5, wherein:
machine learning is performed using the data stored in the database;
a plurality of samples that are included in a previously-determined first percentage of samples, which have been selected in descending order of the prediction score with the deep learning model, and included in a previously-determined second percentage of samples, which have been selected in ascending order of the prediction score with the machine learning; and
the multiple regression analysis is performed with the data of the plurality of samples among the data stored in the database as explanatory variables.

8. A non-transitory computer readable information recording medium storing an information processing program using deep learning when executed by a processor, performs:
performing a prediction process by using a deep learning model on the basis of data stored in a database; and
performing a multiple regression analysis with a result of prediction of the prediction process as an objective variable and with the data as an explanatory variable and determining the variable for use in explaining the prediction result of the deep learning model on the basis of a result of the multiple regression analysis.

9. The information recording medium according to claim 8, wherein the information processing program causes the processor to extract a predetermined number of explanatory variables that better explain the objective variable as variables for use in explaining the prediction result of the deep learning model from the explanatory variables in a multiple regression equation.

10. The information recording medium according to claim 8, wherein the information processing program causes the processor to:
perform machine learning using the data stored in the database;
extract a plurality of samples that are included in a previously-determined first percentage of samples, which have been selected in descending order of the prediction score with the deep learning model, and included in a previously-determined second percentage of samples, which have been selected in ascending order of the prediction score with the machine learning; and
perform the multiple regression analysis with the data of the plurality of samples among the data stored in the database as explanatory variables.

11. The information processing device according to claim 2, the processor further executes the instructions to:
perform machine learning using the data stored in the database; and
extract a plurality of samples that are included in a previously-determined first percentage of samples, which have been selected in descending order of the prediction score with the deep learning model, and included in a previously-determined second percentage of samples, which have been selected in ascending order of the prediction score with the machine learning,
wherein when determining the variable, the processor executes the instructions to perform the multiple regression analysis with the data of the plurality of samples among the data stored in the database as explanatory variables.

12. The information processing method according to claim 6, wherein:
machine learning is performed using the data stored in the database;
a plurality of samples that are included in a previously-determined first percentage of samples, which have been selected in descending order of the prediction score with the deep learning model, and included in a previously-determined second percentage of samples, which have been selected in ascending order of the prediction score with the machine learning; and
the multiple regression analysis is performed with the data of the plurality of samples among the data stored in the database as explanatory variables.

13. The information recording medium according to claim 9, wherein the information processing program causes the processor to:
perform machine learning using the data stored in the database;
extract a plurality of samples that are included in a previously-determined first percentage of samples, which have been selected in descending order of the prediction score with the deep learning model, and included in a previously-determined second percentage of samples, which have been selected in ascending order of the prediction score with the machine learning; and
perform the multiple regression analysis with the data of the plurality of samples among the data stored in the database as explanatory variables.
